(19) United States
(12) Patent Application Publication
(10) Pub. No.: US 2006/0132923 A1
(43) Pub. Date: Jun. 22, 2006

(54) Rearview mirror

(75) Inventors: Yu-Chien Hsiao, Guei Shan (TW); Wen-Wei Su, Guei Shan (TW); Te-Chao Liu, Guei Shan (TW); Kuei-Hung Chen, Guei Shan (TW)

Correspondence Address: TROXELL LAW OFFICE PLLC, SUITE 1404, 5205 LEESBURG PIKE, FALLS CHURCH, VA, 22041, US

(73) Assignee: Exon Science Incorporation

(21) Appl. No.: 10/838,210

(22) Filed: May 5, 2004

(30) Foreign Application Priority Data
Jan. 19, 2004 (TW) 093101349

(51) Int. Cl. G02B 5/08

(52) U.S. Cl. 359/603; 359/870

(57) ABSTRACT

A rearview mirror includes a housing, a frame, a front and a rear glass members retained between the housing and the frame. The front and the rear glass members are sealably bonded together in a spaced-apart relationship to define a chamber receiving an electrochromic medium. The front glass member made of strengthened glass has a higher mechanical strength than the rear glass member made of ordinary glass. When an external force exerts on the rearview mirror, the rear glass member functions as a strain relief device to absorb the striking energy of the external force, thereby preventing the front glass member from being broken.

### BACKGROUND OF THE INVENTION

1. Field of the Invention

The present invention relates to rearview mirrors for motor vehicles, and particularly to rearview mirrors having brilliant safety performance.

2. Description of Related Art

Rearview mirrors are widely used in motor vehicles and have historically been constructed with glass elements. In order to prevent drivers or other people from being wounded, the requirement for safety characteristic of the rearview mirrors becomes more and more strict. FIG. 1 is an schematically experimental view to test the safety of the rearview mirror under the present Europe testing standard. A rearview mirror 5 is installed to a fixed device (not labeled) via a latch member 52. The rearview mirror 5 comprises a housing 53 connected to the latch member 52 via a lever 56, a frame 54 attached to the housing 53 and a glass member 55 retained between the housing 53 and the frame 54. The lever 56 has two fulcrums 51 at two opposite ends thereof. A testing device 6 is a pendulum and includes a pivot 62 for fixing the pendulum and a spherical-shaped hammer 61 at a free end thereof. The hammer 61 is made of hard rubber having enough weight and rigidity. The hammer 61 first rotates upwardly about the pivot 62 via a force exerted thereon until the hammer 61 is formed at an angle of sixty degrees with respect to a vertical plane. Then, the hammer 61 freely and downwardly rotates and arrives at a lowest position where the hammer 61 just knocks against the center of the glass member 55. If the glass member 55 is not broken in appearance, then the rearview mirror 5 passes the safety testing. Contrarily, if the glass member 55 is broken in appearance, in other words, the rearview mirror 5 may be shattered into pieces in an actual car accident, broken glass pieces may harm to drivers or other people, the rearview mirror 5 thus cannot pass the safety testing.

However, regarding the prior Europe testing standard, the lever 56 obliquely extends upwardly to be formed at a predetermined angle with respect to a horizontal plane. When the hammer 61 knocks against the glass member 55, the rearview mirror 5 would move rearwardly and rotate about the two fulcrums 51 of the lever 56, whereby the force received by the glass member 55 is relatively reduced. Thus, under this testing standard, the requirement for safety characteristic of the rearview mirrors is relatively reduced compared to the present Europe testing standard, and most rearview mirrors are easy to pass the safety testing. But under the present Europe testing standard, most rearview mirrors may not pass the safety testing.

Recently, electrochromic mirrors are typical of modern day automatic rearview mirrors for motor vehicles. The electrochromic mirrors are characterized in that an electrochromic medium is employed to be sandwiched and sealed between two glass elements and when the electrochromic medium is electrically energized, it begins to absorb light to allow the mirror to relieve glare, whereby the rearview mirror can be viewed by the driver of the vehicle to provide a clear rearward view. The more light the electrochromic medium absorbs, the darker the mirror appears. When the electrical voltage is decreased to zero, the mirror returns to its clear high reflectance state. Related prior arts of the electrochromic rearview mirrors are disclosed in U.S. Pat. Nos. 4,712,879, 4,741,603, 5,818,625, and 6,535,322. FIG. 2 is a cross-sectional view showing a typical electrochromic mirror. The electrochromic mirror has front and rear glass members 81, 83 and a seal member 82 disposed near the outer perimeter of an inner surface of the front and the rear glass members 81, 83, together defining a sealed chamber 86 therebetween. The sealed chamber 86 is filled with an electrochromic medium for controlling reflectivity of the rearview mirror when the electrochromic medium is electrically energized. The seal member 82 may be any material that is capable of adhesively bonding the inner surfaces of the front and the rear glass members 81, 83 to seal the perimeter such that the electrochromic medium does not leak from the sealed chamber 86. A reflective layer 84 and a protective paint layer 85 are disposed on a rear face of the rear glass member 83.

Since the electrochromic rearview mirror is configured by two glass members and there is a limit to the weight and the volume of the rearview mirror, the thickness of each glass member of the electrochromic rearview mirror is smaller that of the ordinary rearview mirror. Unfortunately, as the thickness of the glass is decreased, the individual glass member becomes more fragile. The electrochromic rearview mirror is more difficult to pass the safety testing under the present Europe testing standard. In order to increase the mechanical strength of the electrochromic mirror, some people have suggested both the front and the rear glass members may be made from strengthened glass having higher mechanical strength. However, such strengthened glass is very costly, thereby increasing the manufacturing cost of the rearview mirror. More importantly, the rearview mirror using the strengthened glass may still be difficult to pass the safety testing under the present Europe testing standard.

Hence, an improved rearview mirror is required to overcome the disadvantages of the related art.

### SUMMARY OF THE INVENTION

Accordingly, an object of the present invention is to provide a rearview mirror having a strain relief device to obtain brilliant safety performance of the rearview mirror.

Another object of the present invention is to provide a rearview mirror with brilliant safety performance and low manufacturing cost.

In order to achieve the objects set forth, a rearview mirror in accordance with the present invention comprises a housing, a frame, a front and a rear glass members retained between the housing and the frame, and a strain relief device arranged at a position where a transmitting path of the striking energy of an external force passes other than the outermost position of the rearview mirror. The front and the rear glass members are sealably bonded together in a spaced-apart relationship to define a chamber receiving an electrochromic medium. The strain relief device has a lower mechanical strength than any other devices on the transmitting path for absorbing the striking energy to prevent the outermost surface of the rearview mirror from being broken.

According to one aspect of the present invention, the front glass member made of strengthened glass has a higher mechanical strength than the rear glass member made of ordinary glass. The rear glass member is the strain relief device.

Other objects, advantages and novel features of the invention will become more apparent from the following detailed description when taken in conjunction with the accompanying drawings.

### BRIEF DESCRIPTION OF THE DRAWINGS

FIG. 1 is a planar view schematically showing a rearview mirror being test under the present Europe testing standard;

FIG. 2 is a cross-sectional view schematically showing a conventional electrochromic rearview mirror;

FIG. 3 is a cross-sectional view schematically showing an electrochromic rearview mirror for motor vehicles in accordance with the present invention;

FIG. 4 is a front planar view of the rearview mirror shown in FIG. 3; and

FIG. 5 is a cross-sectional view of the rearview mirror taken along line A-A of FIG. 4.

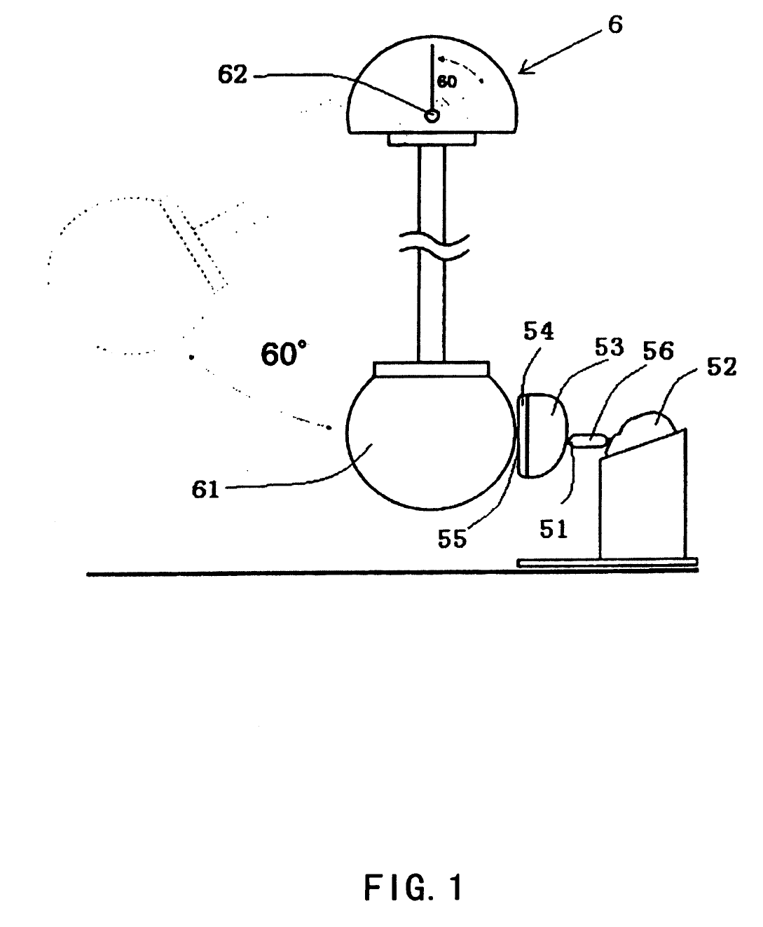

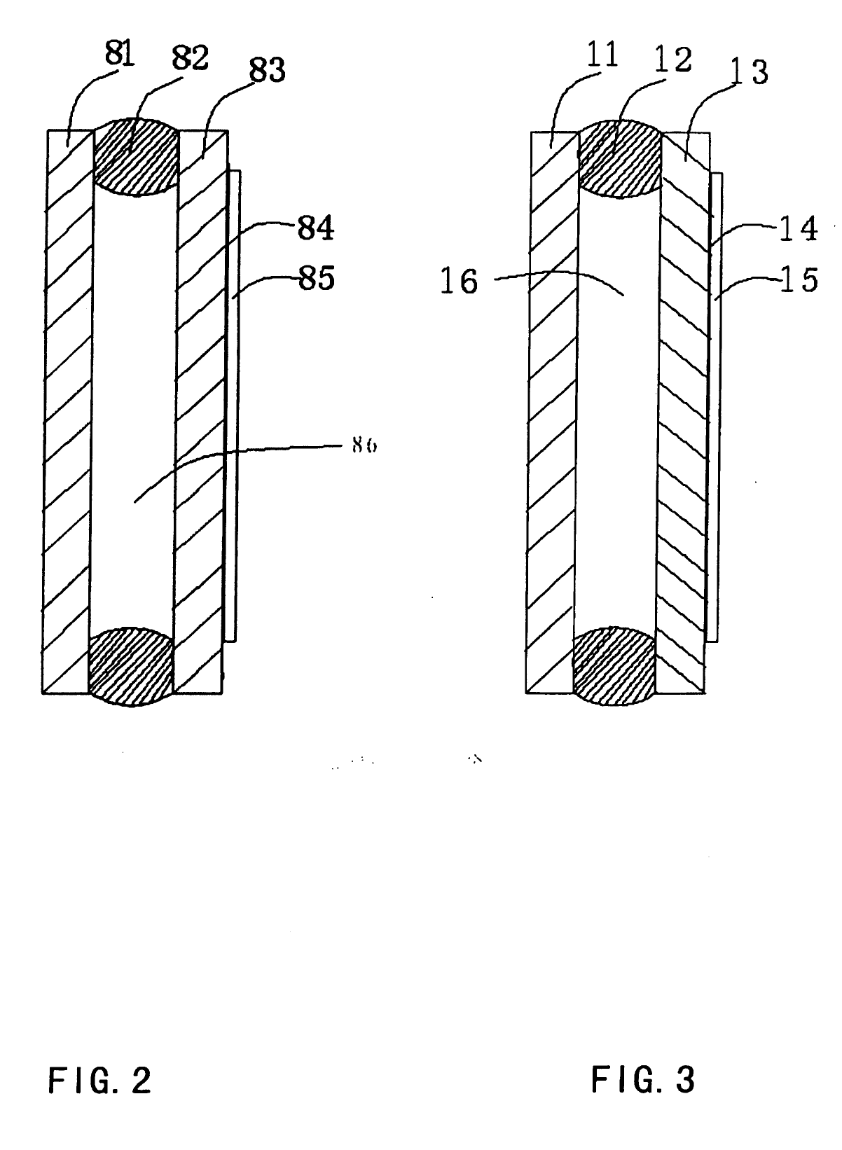

### DETAILED DESCRIPTION OF THE PREFERRED EMBODIMENT

Reference will now be made in detail to the preferred embodiment of the present invention.

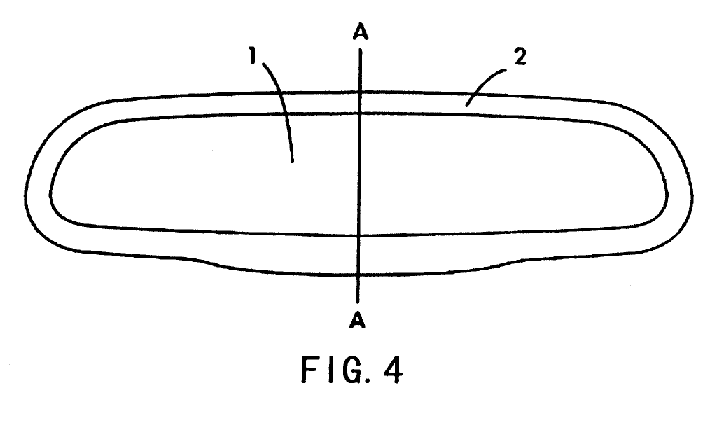

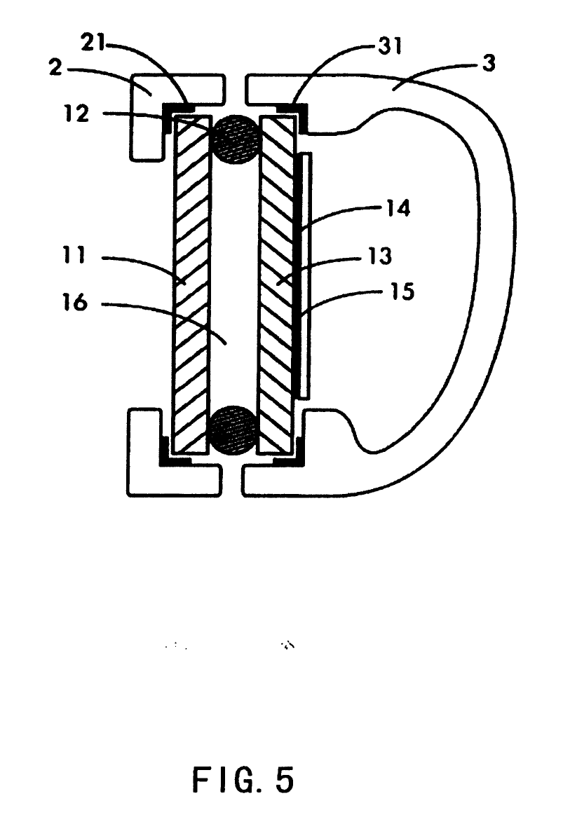

Referring to FIGS. 3-5, a rearview mirror in accordance with the present invention is an electrochromic rearview mirror adapted to be installed in a motor vehicle in a conventional manner such that the mirror faces the rear of the vehicle and can be viewed by the driver of the vehicle to provide a rearward view. The electrochromic rearview mirror comprises a frame 2, a housing 3, and a mirror 1 retained to the housing 3 via the frame 2. The frame 2 and the housing 3 respectively hive a retention portion 21, 31 abutting against the mirror 1. The mirror 1 includes a front glass member 11, a rear glass member 13 and a seal member 12 disposed near the outer perimeter of an inner surface of the front and the rear glass members 11, 13, together defining a sealed chamber 16 therebetween. The sealed chamber 16 is filled with an electrochromic medium for absorbing light when the electrochromic medium is electrically energized. The seal member 12 may be any material that is capable of adhesively bonding the inner surfaces of the front and the rear glass members 11, 13 to seal the perimeter Such that the electrochromic medium does not leak from the sealed chamber 16. A reflective layer 14 and a protective paint layer 15 are disposed on a rear face of the rear glass member 13. For simplicity purpose, other elements such as conductive layers on inner surfaces of the front and the rear glass members 11, 13 are omitted here. The front glass member 11 is made of strengthened glass and has a higher mechanical strength such that the front glass member 11 is not easily broken. The rear glass member 13 is made of ordinary glass and has a lower mechanical strength such that the rear glass member 13 is fragile.

When an external force hits the mirror 1 (such as in a condition where a car accident happens or the above-mentioned safety testing is conducted), the striking energy of this force first exerts on the front glass member 11 and then transmits to the rear glass member 13 through the electrochromic medium accommodated in the sealed chamber 16. Because the electrochromic medium is formed from a liquid or gelatinous material, only a minority of the striking energy is balanced by the deflection of the electrochromic medium and the seal member 12. The front and the rear glass members 11, 13, absorb a majority of the striking energy. Since the force first exerts on the front glass member 11, the front glass member 11 suffers a larger striking energy than the rear glass member 13. If the striking energy is smaller and is within a limit resistive to be broken of the rear original glass member 13, both the front and the rear glass members 11, 13 are not broken. But when the striking energy increases to exceed a limit resistive to be broken of the rear original glass member 13, the rear glass member 13 is broken due to the lower mechanical strength thereof. The rear glass member 13 needs to absorb a large amount of striking energy to make it broken. In this way, the striking energy absorbed by the front glass member 11 is greatly reduced, whereby the front glass member 11 is not broken. Thus, the safety characteristic of the rearview mirror is greatly enhanced. Even if the rearview mirror is subject to a large force, the rear glass member 13 may break into shatters but all glass pieces fall into the sealed chamber 16 to prevent the people from being wounded. At the same time, the front glass member 11 is still intact.

In order to further increase the safety characteristic of the rearview mirror, the retention portion 21 of the frame 2 and the retention portion 31 of the housing 3 are respectively designed as an elastic area. The elastic area may be formed from elastic rubber or any material that can absorb the striking energy. When all external force hits the front glass member 11, the elastic area absorbs the striking energy in part to thereby further increase the safety characteristic of the rearview mirror.

It is understood that a strain relief device in the rearview mirror for absorbing the striking energy may be the rear glass member 13 made of ordinary glass or any device arranged at a position where a transmitting path of the striking energy of an external force passes and having a lower mechanical strength than other devices on the transmitting path.

The rearview mirror of the present invention has brilliant safety performance and can pass the present Europe safety testing. In addition, since the rear glass member 13 is made of ordinary glass, the manufacturing cost of the rearview mirror is reduced. It is noted that although the preferred embodiment of the present invention is the electrochromic rearview mirror, the principles of the present invention can be applied to any accessories used in the motor vehicle and having an fragile surface, such as an ordinary rearview mirror, a dressing mirror, an instrument panel, a Liquid Crystal Display (LCD), a direction finder and so on. The main difference is that except for the electrochromic rearview mirror, there is no sealed chamber formed between the front and the rear glass members for accommodating the electrochromic medium while an outer layer having a higher mechanical strength (the front strengthened glass member) and an inner layer having a lower mechanical strength (the rear original glass member) are directly bonded with each other.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrochromic rearview mirror comprising:
a front and a rear transparent members being sealably bonded together in a spaced-apart relationship to define a chamber;
an electrochromic medium contained in the chamber; wherein
a strain relief device is arranged at a position where a transmitting path of the striking energy of an external force passes other than the outermost position of the rearview mirror, the strain relief device having a lower mechanical strength than other devices on the transmitting path for absorbing the striking energy to prevent the outermost surface of the rearview mirror from being broken.

2. The electrochromic rearview mirror as claimed in claim 1, wherein the front glass member is arranged at the outermost position of the rearview mirror and has a higher mechanical strength than the rear glass member, and wherein the rear transparent member is the strain relief device.

3. The electrochromic rearview mirror as claimed in claim 2, wherein the front transparent member is made of strengthened glass, and the rear transparent member is made of ordinary glass.

4. The electrochromic rearview mirror as claimed in claim 1, wherein the rearview mirror comprises a housing and a frame, the front and the rear glass members are retained between the housing and the frame, and wherein the housing defines an elastic area abutting against the rear transparent member, the elastic area being made from a material that can absorb the striking energy.

5. The electrochromic rearview mirror as claimed in claim 4, wherein the elastic area is made of elastic rubber.

6. The electrochromic rearview mirror as claimed in claim 1, wherein the rear transparent member comprises a reflective layer and a protective paint layer disposed on a rear face thereof.

7. A rearview mirror comprising:
a housing;
a frame;
a mirror element retained between the housing and the frame; wherein
a strain relief device for absorbing the striking energy of an external force which hits the rearview mirror to thereby prevent the outermost surface of the mirror from being broken.

8. The rearview mirror as claimed in claim 7, wherein the mirror element comprises a front and a rear transparent members sealably bonded together tin a spaced-apart relationship to define a chamber, and wherein the rearview mirror comprises an electrochromic medium received in the chamber.

9. The rearview mirror as claimed in claim 8, wherein the front transparent member has a higher mechanism strength than the rear transparent member, and wherein the rear transparent member is the strain relief device.

10. The rearview mirror as claimed in claim 9, wherein the front transparent member is made of strengthened glass, and the rear transparent member is made of ordinary glass.

11. The rearview mirror as claimed in claim 8, wherein the housing defines an elastic area abutting against the rear glass member, the elastic area being made from a material that can absorb the striking energy.

12. The rearview mirror as claimed in claim 11, wherein the elastic area is made of elastic rubber.

13. The rearview mirror as claimed in claim 8, wherein the rear transparent member comprises a reflective layer and a protective paint layer disposed on a rear face thereof.

14. An electrochromic device comprising:
a front and a rear transparent members being sealably bonded together in a spaced-apart relationship to define a chamber;
an electrochromic medium contained in the chamber; wherein
a strain relief device for absorbing the striking energy of an external force which hits the front glass member to thereby prevent the front transparent member from being broken.

15. The electrochromic device as claimed in claim 14, wherein the front transparent member has a higher mechanical strength than the rear transparent member, and wherein the rear transparent member is the strain relief device.

16. The electrochromic device as claimed in claim 15, wherein the front transparent member is made of strengthened glass, and the rear transparent member is made of ordinary glass.

17. The electrochromic device as claimed in claim 14, wherein the electrochromic device comprises a housing and a frame, the front and the rear transparent members are retained between the housing and the frame, and wherein the housing defines an elastic area abutting against the rear transparent member, the elastic area being made from a material that can absorb the striking energy.

18. The electrochromic device as claimed in claim 17, wherein the elastic area is made of elastic rubber.

19. The electrochromic device as claimed in claim 14, wherein the rear transparent member comprises a reflective layer and a protective paint layer disposed on a rear face thereof.

20. An optical processor for using a vehicle, comprising:
an outer layer arranged on a transmitting path of the striking energy of an external force that exerts on the optical processor; and
an inner layer arranged on the transmitting path, the inner layer having a lower mechanical strength than the outer layer; wherein when the external force exceeds a limit resistive to be broken of the inner layer, the inner layer absorbs the striking energy to make the inner layer broken, thereby preventing the outer layer from being broken.

21. The optical processor as claimed in claim 20, wherein the optical processor is any one of a rearview mirror, a dressing mirror, an instrument panel, a Liquid Crystal Display (LCD) and a direction finder.

22. The optical processor as claimed in claim 20, wherein the optical processor is an electrochromic rearview mirror.

23. The optical processor as claimed in claim 22, wherein the outer layer has a higher mechanical strength than the inner layer, and wherein the outer layer is made of strengthened glass, and the inner layer is made of ordinary glass.

24. The optical processor as claimed in claim 23, wherein the outer layer and the inner layer are parallely arranged and are sealably bonded together in a spaced-apart relationship to define a chamber, and wherein the electrochromic rearview mirror comprises an electrochromic medium received in the chamber.

25. The optical processor as claimed in claim 24, wherein the electrochromic rearview mirror comprises a housing and a frame, and wherein the outer layer and the inner layer are retained between the housing and the frame.

26. The optical processor as claimed in claim 25, wherein the frame and the housing respectively define an elastic area respectively abutting against the outer layer and the inner layer.

27. The optical processor as claimed in claim 26, wherein the elastic area is made from a material that can absorb the striking energy.

28. The electrochromic rearview mirror as claimed in claim 2, wherein the rearview mirror comprises a housing and a frame, the front and the rear glass members are retained between the housing and the frame, and wherein the housing defines an elastic area abutting against the rear transparent member, the elastic area being made from a material that can absorb the striking energy.

29. The electrochromic rearview mirror as claimed in claim 3, wherein the rearview mirror comprises a housing and a frame, the front and the rear glass members are retained between the housing and the frame, and wherein the housing defines an elastic area abutting against the rear transparent member, the elastic area being made from a material that can absorb the striking energy.

30. The electrochromic rearview mirror as claimed in claim 2, wherein the rear transparent member comprises a reflective layer and a protective paint layer disposed on a rear face thereof.

31. The electrochromic rearview mirror as claimed in claim 3, wherein the rear transparent member comprises a reflective layer and a protective paint layer disposed on a rear face thereof.

32. The rearview mirror as claimed in claim 9, wherein the housing defines an elastic area abutting against the rear glass member, the elastic area being made from a material that can absorb the striking energy.

33. The rearview mirror as claimed in claim 10, wherein the housing defines an elastic area abutting against the rear glass member, the elastic area being made from a material that can absorb the striking energy.

34. The rearview mirror as claimed in claim 9, wherein the rear transparent member comprises a reflective layer and a protective paint layer disposed on a rear face thereof.

35. The rearview mirror as claimed in claim 10, wherein the rear transparent member comprises a reflective layer and a protective paint layer disposed on a rear face thereof.

36. The electrochromic device as claimed in claim 15, wherein the electrochromic device comprises a housing and a frame, the front and the rear transparent members are retained between the housing and the frame, and wherein the housing defines an elastic area abutting against the rear transparent member, the elastic area being made from a material that can absorb the striking energy.

37. The electrochromic device as claimed in claim 16, wherein the electrochromic device comprises a housing and a frame, the front and the rear transparent members are retained between the housing and the frame, and wherein the housing defines an elastic area abutting against the rear transparent member, the elastic area being made from a material that can absorb the striking energy.

38. The electrochromic device as claimed in 15, wherein the rear transparent member comprises a reflective layer and a protective paint layer disposed on a rear face thereof.

39. The electrochromic device as claimed in 16, wherein the rear transparent member comprises a reflective layer and a protective paint layer disposed on a rear face thereof.
